(19) United States
(12) Patent Application Publication
(10) Pub. No.: US 2007/0041572 A1
(43) Pub. Date: Feb. 22, 2007

(54) Phone and dialing method thereof

(75) Inventor: Hsien Chung Lin, Hsinchu County (TW)

Correspondence Address: REED SMITH LLP, 3110 FAIRVIEW PARK DRIVE, SUITE 1400, FALLS CHURCH, VA, 22042, US

(73) Assignee: BenQ Corporation

(21) Appl. No.: 11/435,823

(22) Filed: May 18, 2006

(30) Foreign Application Priority Data
May 18, 2005 (TW) 94116063

(51) Int. Cl. H04M 1/00

(52) U.S. Cl. 379/357.03

(57) ABSTRACT

A telephone and a dialing method thereof are disclosed. The telephone, communicating with a telecommunication system, has a storage medium for storing a plurality of dialing information. The dialing method includes the following steps: (a) setting a default time period; (b) setting an identification information corresponding to a first dialing information and a second dialing information in the plurality of the dialing information; (c) selecting the first dialing information to operate a first dialing process; (d) proceeding to step (f) when a first response from the telecommunication system responding to the first dialing process; (e) proceeding to step (f) when a first waiting time of the first dialing process exceeding the default time period; and (f) determining whether to select the second dialing information for dialing process.

### CROSS REFERENCE TO RELATED APPLICATIONS

This application claims priority of Taiwan Patent Application Serial No. 094116063 entitled “PHONE AND DIALING METHOD THEREOF” , filed on May 18, 2005.

### FIELD OF THE INVENTION

The present invention relates to a telephone and a dialing method thereof. In particular, it relates to a telephone and a dialing method for performing automatic dialing according to identification information.

### BACKGROUND OF THE INVENTION

In recent years, most people have more than one phone numbers may contact them, such as mobile phone, office telephone, home telephone, etc. Further, it becomes more and more common for people to have more than one mobile phone numbers. It is difficult and inconvenient for a user to remember many telephone numbers so that the mobile phone is typically embedded with internal memory or external SIM card to store these data, such as the Contacts or Phone Book. User may escape from using directly the telephone numbers and just select the name, or other records, from the Phone Book to make a phone call. The mobile phone will perform the dialing process according to the telephone number stored therein automatically.

As the data stored in the mobile phone increases, it costs a lot of time for users to find the number they need. Further, when a connection cannot be successfully established, the telecommunication system responds with voice mailbox, target unavailable, or connection refusal, etc. It is referred to as “response from telecommunication system” hereinafter. In such a condition, user needs to re-select another number to make a new call until a connection is successfully established or until all of the numbers associated with the same target person are already tried and failed. FIG. 1A illustrates a flowchart of a dialing method 100. In step 102, the user selects one contact from the Phone Book. In step 104, the user selects one telephone number from a plurality of telephone numbers of the contact to make a phone call. In step 106, the user determines whether the connection is successfully established. If yes, the communication is made in step 108. If not, the dialing process terminates in step 110. Afterwards, the flow backs to the step 102 and the user re-selects another number to make a new call. It is inefficient and wastes a lot of time to manually repeat the same operations.

In Taiwan Patent No. 529285 (Application No. 90116541), a mobile phone and a dialing method are disclosed. It is incorporated herein for reference. FIG. 1B is a dialing method disclosed by the '285 patent. The method begins in step 112 to perform a dialing process. In step 114, the user determines whether the connection is non-response or line busy. If not, it is determined whether other phone numbers associated with the same contact are available in step 116. If other numbers are available, the user determines whether to perform further dialing process in step 118. If the user determines to make further dialing process, the mobile phone searches the database for the numbers according to contact name or code. The steps 114 to 120 are repeated until a connection is successfully established. If a connection is established in step 114, the communication begins in step 122. After the communication is finished in step 122, or no any numbers are available in step 116, or user decides not to perform further dialing process in step 118, the dialing process is terminated in step 124.

Although the '285 patent identifies the conditions of non-response and line busy, it cannot provide appropriate handles for different situations, such as line busy, target unavailable, voice mailbox, call diverting, or connection refusal, etc. Furthermore, the '285 patent uses a searching program to find the numbers corresponding to the same contact name or code in the database. However, searching the entire database costs additional resource and waiting time. As the technology tends to use larger memory to store the increasing data, searching the database is not an efficient solution.

Therefore, it is advantageous to provide an improved dialing method to create linked dialing information. When a dialing process is not successful, other available phone numbers will be provided efficiently and the dialing process will be handled according to different failure causes.

### SUMMARY OF THE INVENTION

One aspect of the present invention is to provide a telephone with automatic dialing capability and the dialing method thereof, thus the time for the dialing process is decreased and the dialing process is simplified.

The present invention discloses a telephone including a storage medium, a processor, a user interface, a display unit and a notification unit. The storage medium stores a plurality of dialing information thereon. The plurality of dialing information are configured with an identification information corresponding to a first dialing information and a second dialing information. The processor is configured to access the storage medium and perform dialing process. The display unit is configured to displaying a dialing status. A user selects the first dialing information via the user interface and the processor performs a first dialing process according to the first dialing information.

When result of the first dialing process is a response from the telecommunication system or a non-response time period, waiting time, exceeding a default time period, the display unit displaying the second dialing information to the user for determining whether to perform a second dialing process according to the second dialing information.

The present invention discloses a method for use in a telephone. The telephone, communicating with a telecommunication system, has a storage medium for storing a plurality of dialing information. The dialing method includes the following steps: (a) setting a default time period; (b) setting an identification information corresponding to a first dialing information and a second dialing information in the plurality of the dialing information; (c) selecting the first dialing information to operate a first dialing process;

(d) proceeding to step (f) when a first response from the telecommunication system responding to the first dialing process; (e) proceeding to step (f) when a first waiting time of the first dialing process exceeding the default time period; and (f) determining whether to select the second dialing information for dialing process.

### BRIEF DESCRIPTION OF THE DRAWINGS

FIG. 1A illustrates a prior-art dialing method;

FIG. 1B illustrates another prior-art dialing method;

FIG. 2 illustrates a mobile phone according to one embodiment of the present invention;

FIG. 3 illustrates a dialing method according to another embodiment of the present invention; and

FIG. 4 and FIG. 5 illustrate a dialing method according to still another embodiment of the present invention.

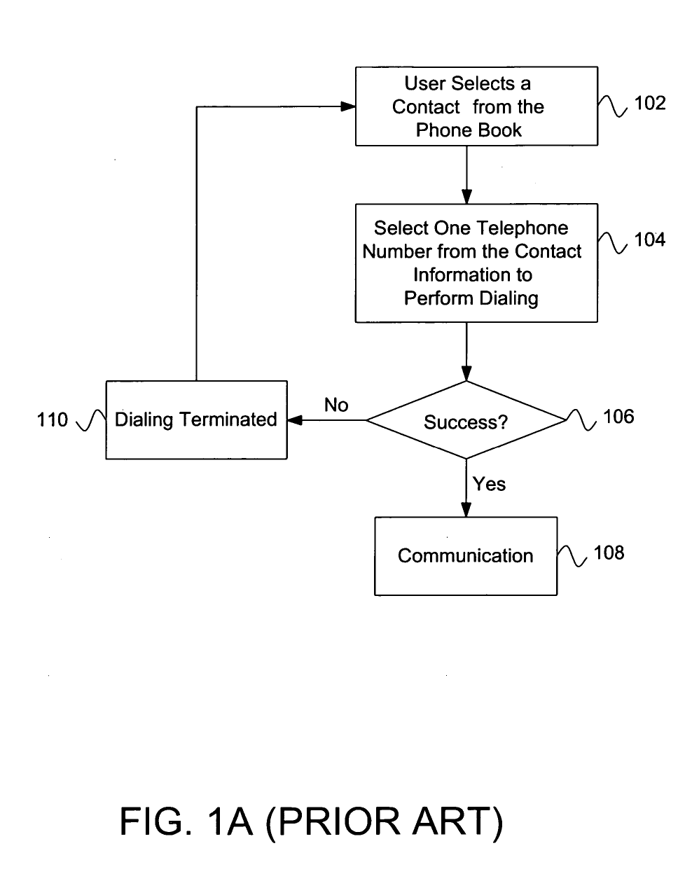

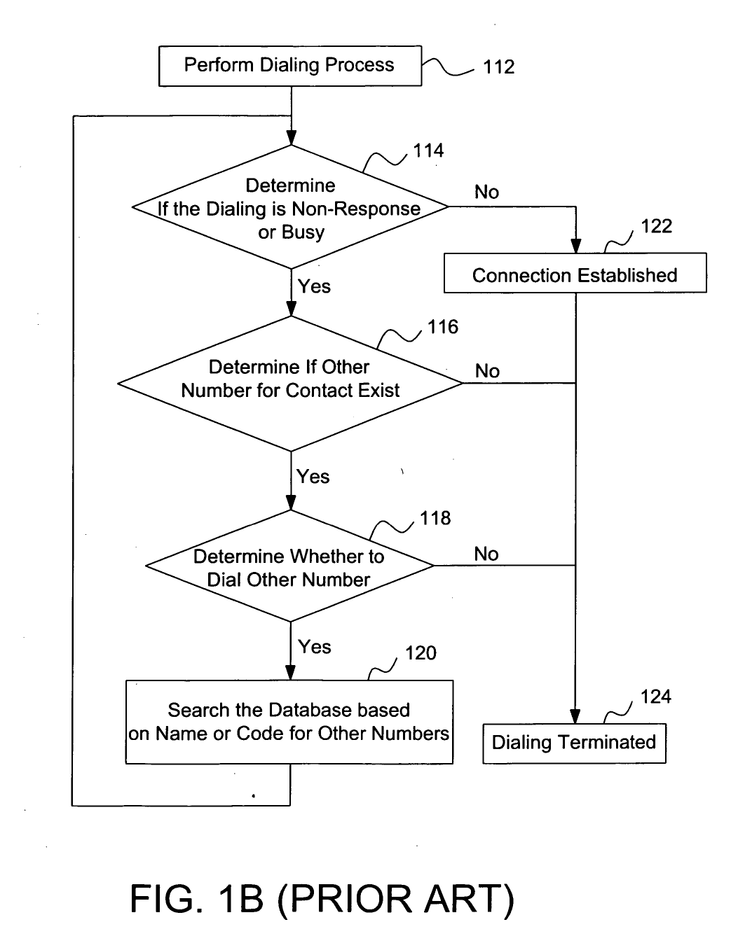

### DETAILED DESCRIPTION OF THE INVENTION

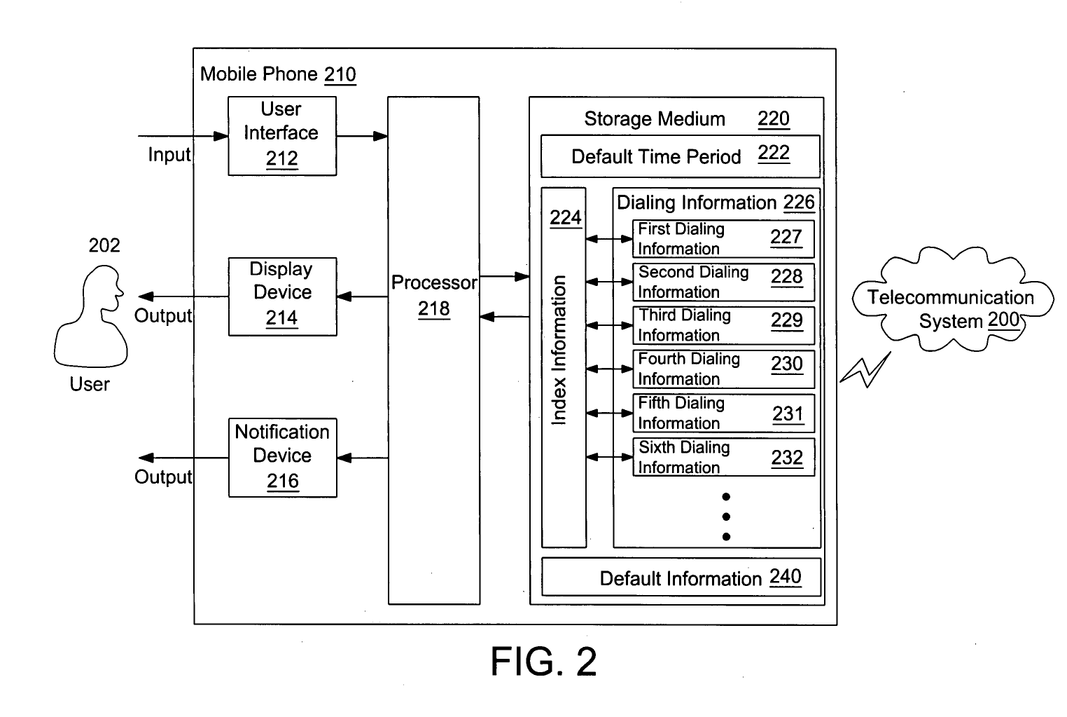

FIG. 2 illustrates a mobile phone 210 for communicating with a telecommunication system 200 according to one embodiment of the present invention.

The telephone system 200 may be any well-known system, such as a PSTN network or a cell phone network. The mobile phone 210 includes a user interface 212, a display device 214, a notification device 216, a processor 218 and a storage medium 220. The storage medium 220 stores information related to the dialing process. In this embodiment, for example, a default time period 222, an index information 224, a plurality of dialing information 226 and default information 240 are stored on the storage medium 220.The storage medium 220 is a memory accessible by the processor 218, such as an internal memory, a removable memory card, an external memory card or a SIM card. In this embodiment, the above-mentioned information is stored in a single physical memory. In other embodiment, the information may also be stored in distributed memories, i.e. a plurality of identical or different physical memories, and the processor may connect to the distributed memories to retrieve the information stored therein.

The processor 218 is configured to access the information stored in the storage medium 220 to perform associated dialing process. It is noted that, for conciseness consideration, the processor 218 is described here only with respect to the dialing process. However, those who skilled in the art may understand that the processor 218 may further perform various functions of the mobile phone, such as voice signal processing, multimedia processing, or SMS/MMS message processing, etc. In this embodiment, the processor 218 is an Integrated Circuit. In other embodiments, the processor may include other similar device, such as programmable logic array (PLA) unit, application-specific integrated circuit (ASIC), or other logic array, etc.

Inputs from the user 202 are received via the user interface 212 and then directed to the processor 218 for performing dialing process. In this embodiment, the user interface 212 is a keypad. In other embodiments, the user interface 212 may include any other similar device, such as a touch pad, a joystick, a knob, or a switch, etc. The display device 214 is configured to displaying dialing status to the user 202. In this embodiment, the display device 214 is a liquid crystal display. In other embodiments, the display device 214 may include any other display device, such as a light emitting diode, or a bulb, etc. The notification device 216 is configured to selectively notify the user 202 according to the result of dialing process. The notification device 216 includes a buzzer, a vibrator, a speaker, or a blinker, etc.

Each dialing information 227-232 corresponds to an index information 224. Each dialing information 227-232 includes identification information, telephone number, and an index link. The identification information generally includes contact name, company name, and nickname, etc. The index link links corresponding identification information to other index information 224. The user 202 may select the dialing information 226 via the user interface 212 to perform the dialing process. For example, the user 202 edits a telephone database including identification information for John and Mary. Three telephone numbers are associated to John and two telephone numbers are associated to Mary. While user 202 wants to make a call to John, user 202 may select one of the three telephone numbers associated to John from the database, or simply input one of the telephone numbers via the user interface 212. Thereafter, a dialing process is activated to make a call to John. In this embodiment, the index information 224 and dialing information 226 are stored in the database using an array structure: “contacts[i]={identification information, telephone number, index link}.” Refer to the following example for the index information 224 and dialing information 226:

TABLE 1

| | |
|---|---|
| Index Information (224) | Dialing Information (226) |

| | | |
|---|---|---|
| contacts[1]= | {John, 0916111333, (3,5)} | (227) |
| contacts[2]= | {Mary, 03111222, (4)} | (228) |
| contacts[3]= | {John, 021115555, (1,5)} | (229) |
| contacts[4]= | {Mary, 0916111222, (2)} | (230) |
| contacts[5]= | {John, 02333444, (1,3)} | (231) |

The index information “contacts[1]” corresponds to a first dialing information 227 including a contact name “John”, mobile phone number, and index link “(3,5)”. The index information “contacts[2]” corresponds to a second dialing information 229 including a contact name “Mary”, office phone number, and index link“(4)” . The index information “contacts[3]” corresponds to a third dialing information 229 including the contact name “John”, office phone number, and index link “(1,5)”. The index information “contacts[4]” corresponds to a fourth dialing information 230 including the contact name “Mary”, home phone number, and index link “(2)”. The index information “contacts[5]” corresponds to a fifth dialing information 231 including the contact name “John”, home phone number, and index link “(1,3)”.

In this embodiment, user 202 predetermined a default time period 222 in the mobile phone 210. When user 202 selects the first dialing information 227 via the user interface 212 to make a call to John, the processor 218 performs a dialing process according to the phone number of the first dialing information 227. When the dialing process is not successful, such as a first response from the telecommunication system or a waiting time period of the dialing process exceeding the default time period, the processor 218 sequentially performs further dialing processes based on the index link“(3,5)” associating this dialing information to the third (contact[3]) and the fifth (contact[5]) dialing information. If all of the above dialing processes are not successful, the processor 218 determines whether to perform auto-reply according to customized settings. In this embodiment, the mobile phone 210 receives a signal from the telecommunication system 200 to determine the response status, such as line busy, target unavailable, voice mailbox or call diverting. The dialing information 226 is stored in the telephone database associating to user 202.

The index link of each dialing information may be used as a dialing sequence to specific identification information. For example, when user 202 makes a call according to the third dialing information 229 and fails, the processor 218 will perform auto-dialing in a sequence indication for index link“(1,5)”, i.e. the phone numbers in the first dialing information and the fifth dialing information. It should be noted that the above descriptions are exemplary rather than limitations, and many other modifications can be made. For example, a two-dimension array contacts [i,j] may be used for the index information 224, wherein i is an index to a specific contact person, and j is an index to one of the dialing information of the specific contact person. Furthermore, many other data structures may be used in the present invention, such as linked list, function, or object, etc. It is described that John has three dialing information (227, 229, 231) and Mary has two dialing information (228, 230) in this example, while more or less dialing information may be used for each contact person.

When user 202 wants to add a new phone number “035551111 ” associated to John in the storage medium 220, a sixth index information “contact [6]” is created. The dialing information 227, 229 and 231 associated to the same contact person “John ” are also modified as following:

TABLE 2

| | | |
|---|---|---|
| contacts[1]= | {John, 0916111333, (3,5,6)} | (227) |
| contacts[3]= | {John, 021115555, (1,5,6)} | (229) |
| contacts[5]= | {John, 02333444, (1,3,6)} | (231) |
| contacts[6]= | {John, 035551111, (1,3,5)} | (232) |

In this embodiment, user 202 initiates the dialing process by selecting one of the dialing information via the user interface 212, and the processor 218 automatically retrieve the other associated dialing information based on the corresponding index link. In other embodiments, user 202 may also initiate the dialing process by directly input a phone number rather than selecting. For example, user 202 inputs a number “021115555” via the keypad, and the processor 218 will detect the inputted number as corresponding to the number of the third dialing information 229 and then selectively perform automatically dialing based on the index link of the third dialing information 229, which links to the first and the fifth index information in Table 1.

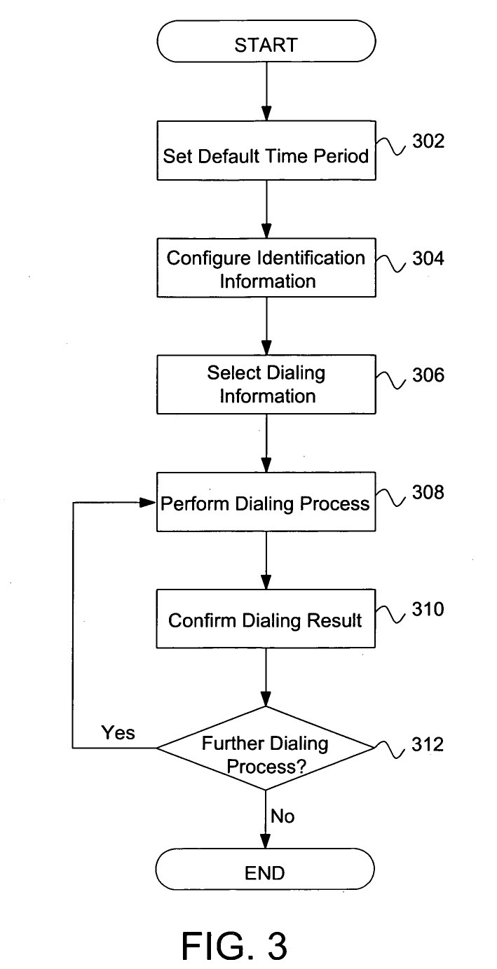

FIG. 3 illustrates a dialing method 300 according to another embodiment of the present invention. The dialing method 300 is used in a telephone, such as the mobile phone 210 described in FIG. 2. The details of the mobile phone 210 have been described above and will be omitted here. In step 302, a default time period 222 is set. Default time period 222 is a predetermined waiting period, and the dialing process is determined as being fail when a success connection is not established after the default time period 222. In step 304, the plurality of dialing information are configured to include identification information, telephone number and index link as shown in Table 1. Each identification information may have more than one dialing information. For example, identification information “John” respectively corresponds to the first dialing information 227, the third dialing information 229, the fifth dialing information 231 and the sixth dialing information 232 as indicated in Table 2. The identification information “Mary” respectively corresponds to the second dialing information 229 and the fourth dialing information 230. In step 306, user 202 selects a dialing information. In step 308, a dialing process is performed according to the selected dialing information. For example, user 202 wants to make a phone call to John and then selects the first dialing information 227 from the dialing information 226 to perform a first dialing process. In step 310, a result of the dialing process is confirmed. The result of the dialing process includes a success connection, a response from the telecommunication system, a waiting time exceeding the default time period, etc. In step 312, a determination is made by user 202 for whether to perform next dialing process. When result of the first dialing process is a success connection, user 202 starts the communication and the method 300 is terminated. When result of the first dialing process is not successful, such as a response from the telecommunication system or a waiting time exceeding the default time period 222, the method proceeds to the step 308 and determines whether to perform further dialing process according to remaining linked dialing information. In this embodiment, the third dialing information 229, the fifth dialing information 231 and the sixth dialing information 232 will be sequentially utilized based on the index link of the first dialing information 227. For example, when the first dialing process for the first dialing information 227 is not successful, the third dialing information is used to perform further dialing process. Similarly, if the dialing process is not successful again, the steps 308 to 312 will be repeated until a success connection is made. It should be noted that user 202 can manually terminate the method 300 in any time although it is not illustrated in FIG. 3.

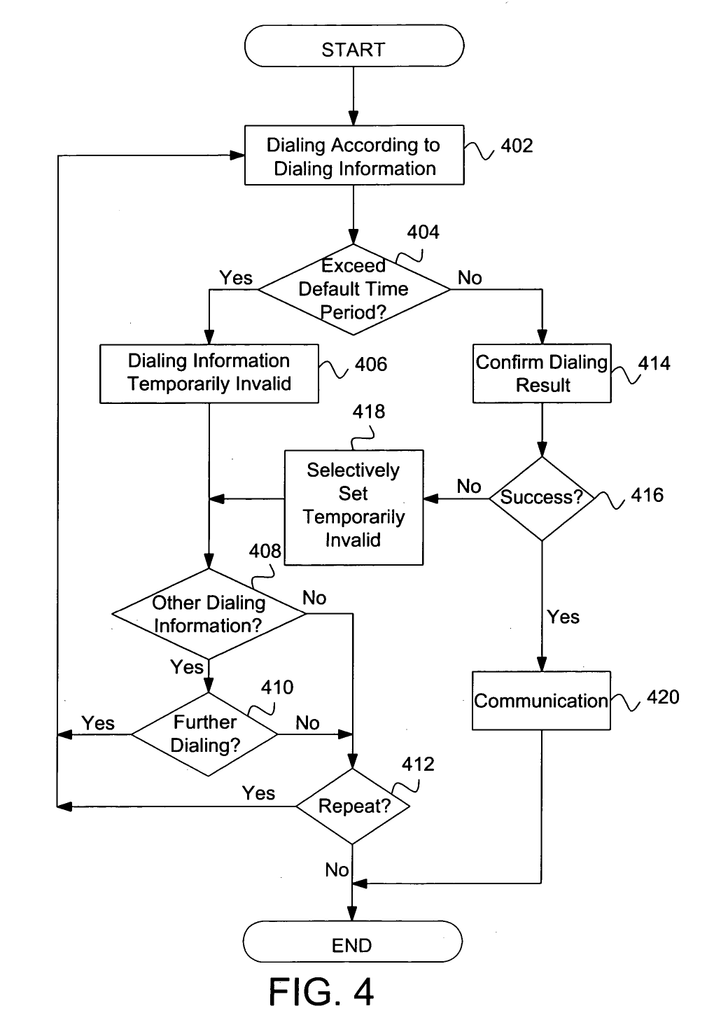

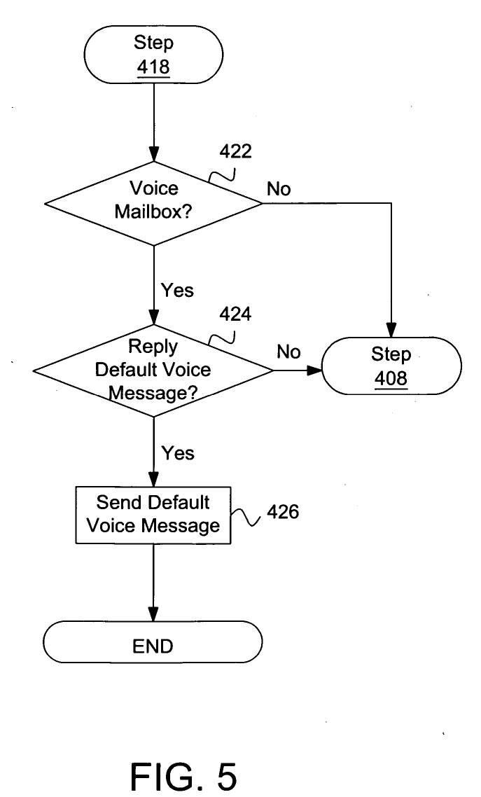

FIG. 4 and FIG. 5 illustrate a dialing method 400 according to still another embodiment of the present invention. Similarly, the mobile phone 210 is used as a hardware to embody the dialing method 400. The method 400 begins with step 402 to select a dialing information to perform a dialing process. For example, the first dialing information 227 is selected to perform a first dialing process. In step 404, it is determined that whether the non-response time period, a waiting time, exceeds the default time period 222. The default time period 222 may be system preset value or a user customized value. If a success connection may not be established after the non-response time period exceeds the default time period 222, the method 400 proceeds to step 406. In step 406, the dialing information is set to be temporarily invalid. In step 408, it is determined whether there are available dialing information associated to the index link of the first dialing information 227. If an available dialing information is found (an not yet be set as temporarily invalid), the method 400 proceeds to step 410. In step 410, it is determined whether to perform further dialing process according to the available dialing information founded in step 408. In this embodiment, the mobile phone 210 displays the available dialing information (e.g. the third dialing information 229) via the display device 214 to user 202. User 202 determines whether to perform further dialing process via the user interface 212. In other embodiments, yes of the step 410 may be performed automatically (in other words, after yes of 408, step proceeds to step 402 without step 410) by the mobile phone 210 to determined whether to continue the dialing process.

If no available dialing information is found in step 408, or a determination is made not to perform further dialing process in step 410, the method 400 proceeds to step 412. In step 412, it is determined whether to repeat the dialing process based on dialing information previously used. If a determination is made to repeat, the method goes back to the step 402 and the dialing process continues. If not, the method 400 is terminated.

If the waiting time does not exceed the default time period 222 and a response signal is received in step 404, the result of the dialing process is confirmed in step 414. For example, a response is received from the teleco determining the result of the dialing process is a success connection, line busy, target unavailable, voice mailbox, call diverting, etc. In step 416, it is determined that whether a success connection is established in the dialing process. If a success connection is not established, the method 400 proceeds to step 418. In step 418, the dialing information is selectively set to be temporarily invalid according to the result of the dialing process. In this embodiment, the dialing information will be set as temporarily invalid when the result of the dialing process is target unavailable and call diverting. In other embodiment, the dialing information may be set as temporarily invalid when any one or more result of the dialing process happens. After the step 418, the method 400 proceeds to step 408 to perform other dialing process. If a success connection is established in step 416, the communication is initiated in step 420 by user and the method 400 is terminated.

FIG. 5 illustrates an additional optional procedure for the method 400. After step 418 of FIG. 4, it is determined whether the telecommunication system 200 returns a response of voice mailbox in step 422. If not, the method 400 proceeds to step 408 of FIG. 4 and continues the procedures described in FIG. 4. If the result is a voice mailbox, it is determined whether to reply a default voice message in step 424. The determination may be manually performed by user 202 or automatically performed by mobile phone 210. For example, if a number is dialed twice and both dialing receive voice mailbox response, the default voice message is replied to the telecommunication system 200. Alternatively, if a voice mailbox response is received and there is no other dialing information available, the default voice message is replied. The default voice message, for example, may be pre-recorded by user 202 which leaves contact information and asks for reply. In this embodiment, the default voice message is stored within the storage medium 220 as the default information 240.

It is noted that the mobile phone 210 displays relevant information, such as current dialing status, via the display device 214 to user 202 when a determination need to be made by user 202 during the method 400. A notification may also be made to user 202 via the notification device 216. Therefore, user 202 needs not keep his full attention on the mobile phone 210 during the entire dialing process. The mobile phone 210 notifies user 202 via the notification device 216 at appropriate times, such as whether to continue dialing in step 410, whether to repeat dialing in step 412, connection established in step 420, whether to reply default voice message in step 424 and/or any other appropriate situations. In step 426, the mobile phone 210 sends the default voice message to the telecommunication system 200 and then terminates the process.

After user 202 finishes the communication with the target contact person, or user 202 manually terminates the method 400 at any step, the mobile phone 210 resets the dialing result, such as resetting the temporarily invalid dialing information to be valid again so that the dialing information may be used next dialing session. Alternatively, user 202 may selectively reset the dialing information. In another embodiment, the dialing information may be reset periodically after a predetermined time period.

RESPONSE FROM TELECOMMUNICATION SYSTEM

In this embodiment, the mobile phone receives a signal from the telecommunication system to confirm the result of the dialing process, such as line busy, target unavailable, voice mailbox, or call diverting. The response from the telecommunication is described in details as following.

In this embodiment, the mobile phone conforms to the third generation telecommunication standard established by the 3^{rd} Generation Partnership Project (3GPP).

It is noted that other telecommunication standard may also be applied in the present invention. Table 3 illustrates Call Fail cause and corresponding response value from the telecommunication system defined in 3GPP 24.008 section 10.5.4.11, including cause value, cause number, cause, diagnostic, etc. Please reference to 3GPP TS 24.008 technical document for further details.

TABLE 3

| Cause value | | | | | | | | | | |
|---|---|---|---|---|---|---|---|---|---|---|
| Class | | | Value | | | | Cause | | | |
| 7 | 6 | 5 | 4 | 3 | 2 | 1 | num. | Cause | Diagnostic | Remarks |
| 0 | 0 | 0 | 0 | 0 | 0 | 1 | 1. | Unassigned (unallocated) number | Note 9 | |
| 0 | 0 | 0 | 0 | 0 | 1 | 1 | 3. | No route to destination | Note 9 | |
| 0 | 0 | 0 | 0 | 1 | 1 | 0 | 6. | Channel unacceptable | — | |
| 0 | 0 | 0 | 1 | 0 | 0 | 0 | 8. | Operator determined barring | — | |
| 0 | 0 | 1 | 0 | 0 | 0 | 0 | 16. | Normal call clearing | Note 9 | |
| 0 | 0 | 1 | 0 | 0 | 0 | 1 | 17. | User busy | Note 1 | |
| 0 | 0 | 1 | 0 | 0 | 1 | 0 | 18. | No user responding | — | |
| 0 | 0 | 1 | 0 | 0 | 1 | 1 | 19. | User alerting, no answer | — | |
| 0 | 0 | 1 | 0 | 1 | 0 | 1 | 21. | Call rejected | Note 9 - | |
| | | | | | | | | | user supplied diagnostic | |
| | | | | | | | | | (note 4) | |
| 0 | 0 | 1 | 0 | 1 | 1 | 0 | 22. | Number changed | New destination(note 5) | |
| 0 | 0 | 1 | 1 | 0 | 0 | 1 | 25. | Pre-emption | | |
| 0 | 0 | 1 | 1 | 0 | 1 | 0 | 26. | Non selected user clearing | — | |
| 0 | 0 | 1 | 1 | 0 | 1 | 1 | 27. | Destination out of order | — | |
| 0 | 0 | 1 | 1 | 1 | 0 | 0 | 28. | Invalid number format (incomplete number) | — | |
| 0 | 0 | 1 | 1 | 1 | 0 | 1 | 29. | Facility rejected | Note 1 | |
| 0 | 0 | 1 | 1 | 1 | 1 | 0 | 30. | Response to STATUS ENQUIRY | — | |
| 0 | 0 | 1 | 1 | 1 | 1 | 1 | 31. | Normal, unspecified | — | |
| 0 | 1 | 0 | 0 | 0 | 1 | 0 | 34. | No circuit/channel available | Note 1 | |
| 0 | 1 | 0 | 0 | 1 | 1 | 0 | 38. | Network out of order | — | |
| 0 | 1 | 0 | 1 | 0 | 0 | 1 | 41. | Temporary failure | — | |
| 0 | 1 | 0 | 1 | 0 | 1 | 0 | 42. | Switching equipment congestion | — | |
| 0 | 1 | 0 | 1 | 0 | 1 | 1 | 43. | Access information discarded | Discarded information | |
| | | | | | | | | | element identifiers | |
| | | | | | | | | | (note 6) | |
| 0 | 1 | 0 | 1 | 1 | 0 | 0 | 44. | requested circuit/channel not available | — | |
| 0 | 1 | 0 | 1 | 1 | 1 | 1 | 47. | Resources unavailable, unspecified | — | |
| 0 | 1 | 1 | 0 | 0 | 0 | 1 | 49. | Quality of service unavailable | Note 9 | |
| 0 | 1 | 1 | 0 | 0 | 1 | 0 | 50. | Requested facility not subscribed | Note 1 | |
| 0 | 1 | 1 | 0 | 1 | 1 | 1 | 55. | Incoming calls barred within the CUG | Note 1 | |
| 0 | 1 | 1 | 1 | 0 | 0 | 1 | 57. | Bearer capability not authorized | Note 3 | |
| 0 | 1 | 1 | 1 | 0 | 1 | 0 | 58. | Bearer capability not presently available | Note 3 | |
| 0 | 1 | 1 | 1 | 1 | 1 | 1 | 63. | Service or option not available, unspecified | — | |
| 1 | 0 | 0 | 0 | 0 | 0 | 1 | 65. | Bearer service not implemented | Note 3 | |
| 1 | 0 | 0 | 0 | 1 | 0 | 0 | 68. | ACM equal to or greater than ACMmax | | |
| 1 | 0 | 0 | 0 | 1 | 0 | 1 | 69. | Requested facility not implemented | Note 1 | |
| 1 | 0 | 0 | 0 | 1 | 1 | 0 | 70. | Only restricted digital information | | |
| | | | | | | | | bearer capability is available | | |
| 1 | 0 | 0 | 1 | 1 | 1 | 1 | 79. | Service or option not implemented, unspecified | — | |
| 1 | 0 | 1 | 0 | 0 | 0 | 1 | 81. | Invalid transaction identifier value | — | |
| 1 | 0 | 1 | 0 | 1 | 1 | 1 | 87. | User not member of CUG | Note 1 | |
| 1 | 0 | 1 | 1 | 0 | 0 | 0 | 88. | Incompatible destination | Incompatible parameter | |
| | | | | | | | | | (Note 2) | |
| 1 | 0 | 1 | 1 | 0 | 1 | 1 | 91. | Invalid transit network selection | — | |
| 1 | 0 | 1 | 1 | 1 | 1 | 1 | 95. | Semantically incorrect message | — | |
| 1 | 1 | 0 | 0 | 0 | 0 | 0 | 96. | Invalid mandatory information | Information element | |
| | | | | | | | | | identifier(s) | |
| 1 | 1 | 0 | 0 | 0 | 0 | 1 | 97. | Message type non-existent or not implemented | Message type | |
| 1 | 1 | 0 | 0 | 0 | 1 | 0 | 98. | Message type not compatible with protocol state | Message type | |
| 1 | 1 | 0 | 0 | 0 | 1 | 1 | 99. | Information element non-existent or not | Information element | |
| | | | | | | | | implemented | identifier(s) (notes 6, 7) | |
| 1 | 1 | 0 | 0 | 1 | 0 | 0 | 100. | Conditional IE error | Information element | |
| | | | | | | | | | identifier(s) (note 6) | |
| 1 | 1 | 0 | 0 | 1 | 0 | 1 | 101. | Message not compatible with protocol state | Message type | |
| 1 | 1 | 0 | 0 | 1 | 1 | 0 | 102. | Recovery on timer expiry | Timer number (note 8) | |
| 1 | 1 | 0 | 1 | 1 | 1 | 1 | 111. | Protocol error, unspecified | — | |
| 1 | 1 | 1 | 1 | 1 | 1 | 1 | 127. | Interworking, unspecified | — | |

In this embodiment, the Call Fail causes listed in Table 3 are rewritten in user able messages as shown in Table 4. Therefore, the mobile phone may automatically determine the result of dialing process based on the signal and token listed in Table 4. It should be noted both Table 3 and Table 4 are illustrated for exemplary purposes rather limitations to the present invention. For example, the mobile phone may identify a diverting from the signal SIG_APEX_CC_CALL_FORWARDED_IND in one embodiment. Alternatively, the mobile phone may display meaning of the signal via the display device for user to determine whether to continue dialing process.

TABLE 4

| Signal | Token | Meaning |
|---|---|---|
| {APEX_CAUSE_OK, | TOKEN_CC_DISCONNECTING} | Disconnect |
| {APEX_CAUSE_SUBSCRIBER_BUSY, | TOKEN_CC_ENGAGED} | Line Busy |
| {APEX_CAUSE_CONGESTION, | TOKEN_CC_CHANNEL_BUSY} | System Busy |
| {APEX_CAUSE_RADIO_PATH_UNAVAIL, | TOKEN_CC_CHANNEL_BUSY} | System Busy |
| {APEX_CAUSE_NUM_UNOBTAINABLE, | TOKEN_CC_NUM_UNOBTAINABLE} | Wrong Number |
| {APEX_CAUSE_AUTH_FAILURE, | TOKEN_CC_AUTH_FAILURE} | Authorization Failure |
| {APEX_CAUSE_BL_MM_FAILURE, | TOKEN_CC_AUTH_FAILURE} | Authorization Failure |
| {APEX_CAUSE_CLIR_NOT_SUBSCRIBED, | TOKEN_CC_NO_CALLER_ID} | Caller ID Disable |
| {APEX_CAUSE_CHANNEL_BUSY, | TOKEN_CC_CHANNEL_BUSY} | System Busy |
| {APEX_CAUSE_FDN_MISMATCH, | TOKEN_CC_FDN_MISMATCH} | Dialing Limitation |
| {APEX_CAUSE_BC_FAIL | TOKEN_CC_BC_FAIL} | Format Error |
| {APEX_CAUSE_EMERGENCY_CALLS_ONLY, | TOKEN_CC_EMERGENCY_ONLY} | Emergency Call Only |
| {APEX_CAUSE_ACM_LIMIT_EXCEEDED, | TOKEN_CC_ACM_EXCEEDED} | ACM Limit Exceeded |
| {APEX_CAUSE_HOLD_ERROR, | TOKEN_CC_HOLD_ERROR} | Call Hold Error |
| {APEX_CAUSE_BUSY_PROCESSING_REQUEST, | TOKEN_CC_BUSY_PROCESSING} | Line Busy, Please Wait |
| {APEX_CAUSE_ACTIVE_CHANNEL_UNAVAILABLE, | TOKEN_CC_ACTIVE_BUSY} | Active Busy |
| {APEX_CAUSE_OUTGOING_CALL_BARRED, | TOKEN_CC_CALLS_BARRED} | Calls Barred |
| {APEX_CAUSE_NUMBER_BLACKLISTED, | TOKEN_CC_BLACKLISTED} | Redial Failure |
| {APEX_CAUSE_BLACKLIST_FULL, | TOKEN_CC_BLACKLIST_FULL} | Redial List Full |
| {APEX_CAUSE_NOT_IN_CONTROL, | TOKEN_CC_NO_CONTROL} | Dialing Failure |
| {APEX_CAUSE_ERROR, | TOKEN_CC_CALL_ERROR} | Connection Error |
| {NUM_OF_APEX_CAUSES, | AG_NULL_ELEMENT} | |

PROGRAM CODE

The following program code is illustrated for exemplary purpose to implement the method 300. Those who skilled in the art may understand the details of the embodiment. Many modifications may also be made without departing the spirit of the persent invention.

/************************************************
Type Definitions
*************************************************/
#define MAX_CONTACTS_NUMBER 250
#define MAX_PHONE_LINK_NUMBER 3
typedef struct ContactsTag
{

Int16 Name[20];
Int16 PhoneNumber[20];
Int16 PhoneLink[MAX_PHONE_LINK_NUMBER];
Int8 Available;

}Contacts;
typedef enum
{

NO SIGNAL,
END OF CALL,
TIMEOUT,
NUMBER_OF_STATES=0xFF

}MakeCallState;
Contacts contacts[MAX_CONTACTS_NUMBER];
Int8 PhoneLinkIndex = 0;
Timer UserDefinedWaitTime;
/************************************************
Function Definitions
************************************************/
static void MakePhoneCall (Int16 Index)
{

MakeCallState CallState;
CallState = MakeCall(contacts[Index].PhoneNumber,
UserDefinedWaitTime);
Switch(CallState)
{

case NO_SIGNAL;
case END_OF_CALL;

EndCall( );

Case TIMEOUT;
if(PhoneLinkIndex < MAX_PHONE_LINK_NUMBER)
{

if((contacts[Index].PhoneLink[PhoneLinkIndex]
!= NULL) && (contacts[Index].Available !=0))
{

if(ContinueQuery( ))
{

MakePhoneCall(contacts[Index].PhoneLink[PhoneLinkIndex]);

PhoneLinkIndex ++;

}
else

EndCall( );

}
else

EndCall( );

}
else

EndCall( );

break;
default;
break;

}

}
/************************************************/

The above description sets forth various preferred embodiments of the invention only, and is not intended to limit the scope, applicability, or configuration of the invention in any way. Rather, various changes may be made in the function and arrangement of the elements described in these embodiments without departing from the spirit and scope of the invention. Thus, the protected scope of the present invention is as set forth in the appended claims.

what is claimed is:

1. A dialing method for use in a telephone having a storage medium for storing a plurality of dialing information, the telephone using for communicating with a telecommunication system, the method comprising the steps of:
(a) setting a default time period;
(b) setting an identification information in the plurality of dialing information, the identification information corresponding to a first dialing information and a second dialing information;
(c) selecting the first dialing information to perform a first dialing process;
(d) proceeding to step (f) when a first response from the telecommunication system responding to the first dialing process;
(e) proceeding to step (f) when a first waiting time of the first dialing process exceeding the default time period; and
(f) determining whether to select the second dialing information for dialing process.

2. The method according to claim 1, further comprising:
(g) performing a second dialing process according to the second dialing information;
(h) proceeding to step (j) when a second response from the telecommunication system responding to the second dialing process;
(i) proceeding to step (j) when a second waiting time of the second dialing process exceeding the default time period; and
(j) determining whether to perform step (c) to step (f) when no other dialing information corresponding to the identification information is available.

3. The method according to claim 1, wherein the step (f) further comprises the steps of:
displaying the second dialing information; and
determining whether to perform the second dialing process according the second dialing information.

4. The method according to claim 1, further comprising the steps of:
configuring the first dialing information to include the identification information, a first telephone number, and a first index link, the first dialing information corresponding to a first index information;
configuring the second dialing information to include the identification information, a second telephone number, and a second index link, the second dialing information corresponding to a second index information;
wherein, the first index link comprises the second index information and the second index link comprises the first index information.

5. The method according to claim 4, further comprising the steps of:
inputting the first telephone number to the telephone; and
selecting the first dialing information according to the first telephone number.

6. The method according to claim 4, further comprising the steps of:
configuring a third dialing information to include the identification information, a third telephone number, and a third index link, the third dialing information being corresponding to a third index information; and
updating the first index link to include the second index information and the third index information;
updating the second index link to include the first index information and the third index information; and
configuring the third index link to include the first index information and the second index information.

7. The method according to claim 4, wherein the step (f) further comprises selecting the second dialing information according to the first index link.

8. The method according to claim 1, wherein the first response and the second response from the telecommunication system include at least one of the following:
busy, target unavailable, voice mailbox and call diverting.

9. The method according to claim 8, wherein when the firs dialing process is performed and the first response from the telecommunication system is target unavailable or call diverting, setting the first dialing process to be temporarily invalid.

10. The method according to claim 8, wherein when the firs dialing process is performed and the first response from the telecommunication system is voice mailbox, the method further comprises replying a default voice message.

11. A telephone for communicating with a telecommunication system, the telephone comprises:
a storage medium for storing a plurality of dialing information, the plurality of dialing information being configured with an identification information, the identification information corresponding to a first dialing information and a second dialing information;
a processor for accessing the storage medium and performing dialing process;
an user interface; and
a display unit for displaying a dialing status;
wherein a user selects the first dialing information via the user interface and the processor performs a first dialing process according to the first dialing information, and wherein when a first response from the telecommunication system response to the first dialing process or a waiting time of the first dialing process exceeding a default time period, the display unit displaying the second dialing information for determining whether to perform a second dialing process according to the second dialing information.

12. The telephone according to claim 11, wherein when the second dialing process is performed and a second response from the telecommunication system responding to the second dialing process or a second waiting time exceeding the default time period, the process detects whether there is other available dialing information corresponding to the identification information.

13. The telephone according to claim 12, wherein when there is no other available dialing information corresponding to the identification information, the processor determines whether to re-perform the first and the second dialing process.

14. The telephone according to claim 11, wherein:
the first dialing information includes the identification information, a first telephone number, and a first index link, and the first dialing information corresponds to a first index information; and
the second dialing information includes the identification information, a second telephone number, and a second index link, and the second dialing information corresponds to a second index information;
and wherein, the first index link comprises the second index information and the second index link comprises the first index information.

15. The telephone according to claim 14, wherein when the user inputs the first telephone number via the user interface, the processor selects the first dialing information according to the first telephone number for performing the first dialing process.

16. The telephone according to claim 14, wherein the storage medium further comprises:
a third dialing information including the identification information, a third telephone number, and a third index link, the third dialing information corresponding to a third index information and the third index link including the first index information and the second index information;
and wherein, the process updates the first index link to include the second index information and the third index information, and updates the second index link to include the first index information and the third index information.

17. The telephone according to claim 14, wherein the processor selects the second dialing information according to the first index link.

18. The telephone according to claim 11, further comprises a notification unit for notifying the result of dialing process to the user.

19. The telephone according to claim 11, wherein the first response and the second response from the telecommunication system include at least one of the following:
busy, target unavailable, voice mailbox and call diverting.

20. The telephone according to claim 19, wherein when the firs dialing process is performed and the first response from the telecommunication system is target unavailable or call diverting, setting the first dialing process to be temporarily invalid.

21. The telephone according to claim 19, wherein when the firs dialing process is performed and the first response from the telecommunication system is voice mailbox, the method further comprises replying a default voice message.
